(19) United States
(12) Patent Application Publication
(10) Pub. No.: US 2013/0048744 A1
(43) Pub. Date: Feb. 28, 2013

(54) FLUID CONTROL APPARATUS

(71) Applicants: Masaki Fujita, Osaka-shi (JP); Izuru Shikata, Osaka-shi (JP); Takahiro Matsuda, Osaka-shi (JP)

(72) Inventors: Masaki Fujita, Osaka-shi (JP); Izuru Shikata, Osaka-shi (JP); Takahiro Matsuda, Osaka-shi (JP)

(73) Assignee: FUJIKIN INCORPORATED, Osaka-shi (JP)

(21) Appl. No.: 13/596,173

(22) Filed: Aug. 28, 2012

(30) Foreign Application Priority Data
Aug. 30, 2011 (JP) 2011-186968

(51) Int. Cl. G05D 7/00

(52) U.S. Cl. 236/93 R

(57) ABSTRACT

A space S is formed between a fluid control device 6 requiring temperature measurement and a support member 9. A thermostat unit 10 is arranged in the space S, and a thermostat 11 is allowed to abut on the fluid control device 6 requiring the temperature measurement. The thermostat 11 is supported by an attachment jig 12 attached to the support member 9. The attachment jig 12 is made up of a first jig 13 fixed to the support member 9, a second jig 14 fixed to the first jig 13, and a third jig 15 shiftably attached to the second jig 14 and to which the thermostat 11 is fixed. A biasing member is interposed between the first jig 13 and the third jig 15.

### BACKGROUND OF THE INVENTION

The present invention relates to a fluid control apparatus used in a semiconductor manufacturing apparatus or the like. In particular, the present invention relates to a fluid control apparatus made up of a plurality of fluid control devices being integrated.

In connection with the fluid control apparatus used in a semiconductor manufacturing apparatus, what is promoted is integration of lines, which are a plurality of fluid control devices arranged adjacent to one another and attached to support members, in parallel to one another on a base member, so that a fluid control apparatus is structured without through the use of pipes or joints. In some cases, heating means is provided thereto (Japanese Unexamined Patent Application Publication No. 2006-349075).

Such a fluid control apparatus sometimes requires a thermostat. Though an example of attaching a thermostat is disclosed in Japanese Unexamined Patent Application Publication No. 2008-64551, no example of attaching a thermostat to an integrated fluid control apparatus is known.

With the conventional fluid control apparatus, since a plurality of fluid control devices are arranged so as to be adjacent to one another and attached to the support member, an adequate space is not secured on the front and back sides of the fluid control device which requires provision of a thermostat, and installation thereof is difficult.

### SUMMARY OF THE INVENTION

An object of the present invention is to provide a fluid control apparatus with which installation of a thermostat is facilitated.

A fluid control apparatus according to the present invention includes: a support member; a plurality of fluid control devices including a fluid control device requiring temperature measurement, a plurality of the fluid control devices being arranged so as to be adjacent to one another and attached to the support member; and a space formed between the fluid control device requiring the temperature measurement and the support member. The thermostat is arranged in the space and allowed to abut on the fluid control device requiring the temperature measurement.

When the thermostat is to be arranged between adjacent ones of the fluid control devices, attachment and removal of the thermostat is difficult because the interval between adjacent ones of the fluid control devices is narrow. In some cases, there is a problem that the thermostat cannot be installed. Using the space between the fluid control device requiring the temperature measurement and the support member, such a problem can be solved.

As the fluid control device that requires the temperature measurement, though devices that control the flow rate of various types of process gas such as a mass flow controller (MFC), a flow control system (FCS) and the like are suitable, the present invention is not limited thereto. It is preferable that the fluid control apparatus is provided with heating means for controlling the temperature using the thermostat.

Preferably, the thermostat is supported by an attachment jig attached to the support member, and is pressed against the fluid control device requiring the temperature measurement by a biasing member.

When the thermostat is attached to the fluid control device, the thermostat must be removed and attached when the fluid control device is replaced. However, since the thermostat is supported by the attachment jig attached to the support member, solely the fluid control device can be replaced. Since the thermostat is not directly fixed to the fluid control device, the sensitivity of the thermostat may be reduced. However, by the thermostat being pressed against the fluid control device by the biasing member, such a reduction in sensitivity of the thermostat can be prevented. Further, by compressing the biasing member, works such as inserting the attachment jig supporting the thermostat into and taking out the attachment jig from the space can easily be performed.

It is preferable that the attachment jig is made up of a first jig fixed to the support member, a second jig fixed to the first jig, and a third jig shiftably attached to the second jig, the thermostat being fixed to the third jig, and the biasing member is interposed between the first jig and the third jig.

In this manner, changing the shape of the third jig so as to correspond to the thermostat to be used, the present invention can address various thermostats. In addition, since the first jig fixed to the support member has the spring bearing function, the structure of the attachment jig can be simplified, and the work of allowing the thermostat to be supported by the attachment jig, the work of assembling the attachment jig, and the work of attaching the attachment jig to the support member can easily be performed.

The biasing member is, e.g., a compressed coil spring, which is fitted from below into at least one downward projecting portion provided at the top wall of the third jig, and is held by the top wall of the third jig and the first jig therebetween. However, the present invention is not particularly limited thereto. The spring may be any spring in addition to the compression coil type, and the number of pieces thereof can also appropriately be set.

Preferably, the thermostat is substantially oblong plate-shaped. A lead is lead out from one end portion of the thermostat. The longitudinal direction of the thermostat is diagonally oriented with reference to the direction in which the fluid control devices are aligned.

In this manner, the space can effectively be used, and the lead of the thermostat can easily be lead out. Depending on the dimension of the space near the fluid control device, the longitudinal direction of the thermostat may be oriented in parallel to the direction in which the fluid control devices are aligned, or in the direction being perpendicular thereto.

As the thermostat, any commercially available thermostat may be used. A wide variety of dimension (the length, the width, and the thickness), attachment portions (screws, brackets and the like), leads and the like thereof are available. By appropriately changing the structure of the third jig so as to correspond to the form of the thermostat, and appropriately changing the structure of the second jig and that of the first jig accordingly, a thermostat of various shapes can be used.

With the fluid control apparatus of the present invention, using the space formed between the fluid control device requiring the temperature measurement and the support member, the thermostat is arranged. Accordingly, the thermostat can easily be installed in a fluid control apparatus in which an interval between adjacent ones of the fluid control devices is narrow.

### BRIEF DESCRIPTION OF THE DRAWINGS

FIG. 1 is a front view showing an embodiment of a fluid control apparatus of the present invention;

FIG. 2 is a plan view of the fluid control apparatus of the present invention;

FIG. 3 is a front view showing a thermostat unit being a substantial part of the fluid control apparatus of the present invention;

FIG. 4 is a plan view of the thermostat unit;

FIG. 5 is a perspective view of a first jig structuring the thermostat unit;

FIG. 6 is a perspective view of a second jig structuring the thermostat unit;

FIG. 7 is a perspective view of a third jig structuring the thermostat unit; and

FIGS. 8A to 8F are front views showing the procedure of assembling the thermostat unit.

### DETAILED DESCRIPTION OF PREFERRED EMBODIMENTS

With reference to the drawings, a description will be given of an embodiment of the present invention.

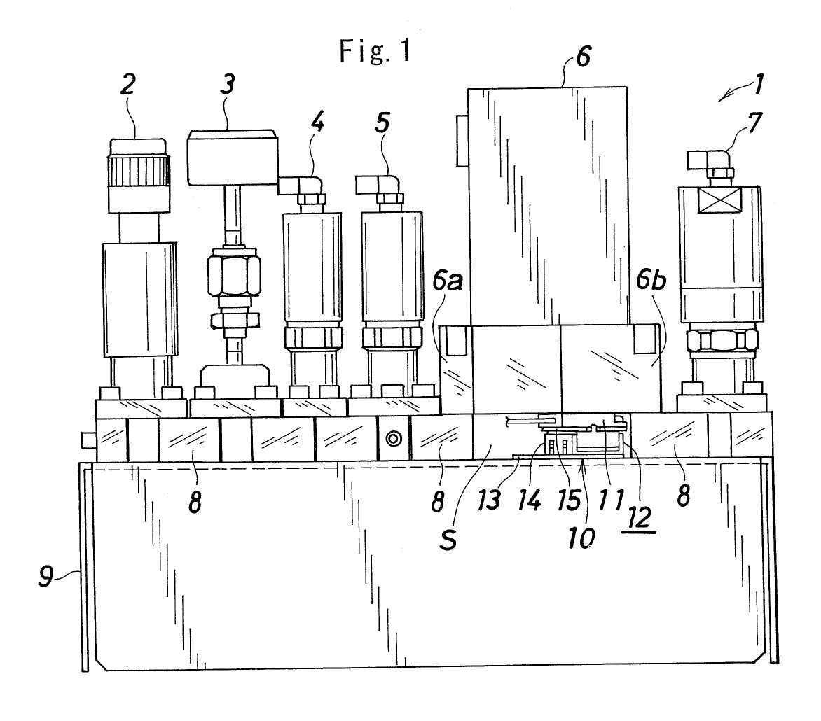

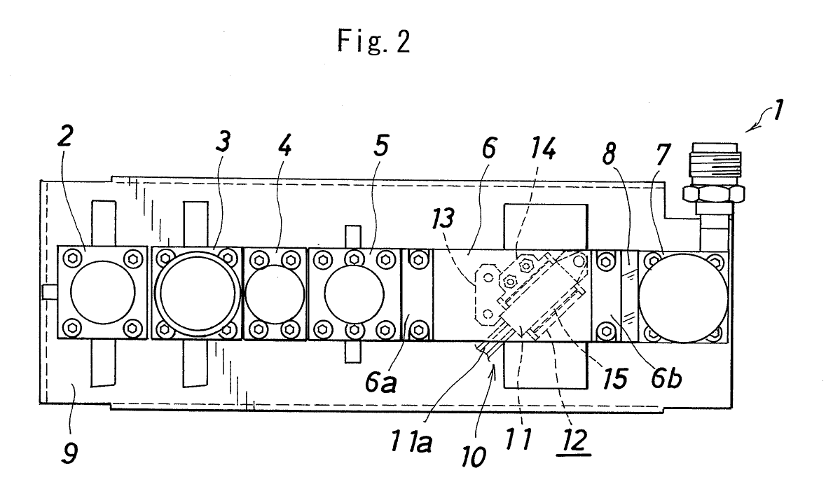

FIGS. 1 and 2 each show a fluid control apparatus of the present invention. The fluid control apparatus 1 is used in a semiconductor manufacturing apparatus or the like, and includes a plurality of fluid control devices 2, 3, 4, 5, 6, and 7 arranged at the upper level, a plurality of block joints 8 arranged at the lower level to support a plurality of fluid control devices 2, 3, 4, 5, 6, and 7, a support member 9 supporting a plurality of block joints 8, a thermostat unit 10 attached to a fluid control device 6 that exerts flow rate control out of a plurality of fluid control devices 2, 3, 4, 5, 6, and 7, and heating means (not shown) for heating part of or all of a plurality of fluid control devices 2, 3, 4, 5, 6, and 7 and a plurality of block joints 8.

The fluid control apparatus 1 is structured with a plurality of lines arranged so as to be parallel to one another, each line of which is the line shown in the drawing.

The thermostat unit 10 is structured with a thermostat 11 supported by an attachment jig 12. The attachment jig 12 has a first jig 13 fixed to the support member 9, a second jig 14 fixed to the first jig 13, and a third jig 15 shiftably attached to the second jig 14, the thermostat 11 being fixed to the third jig 15.

The thermostat unit 10 is attached to the fluid control device 6 that requires temperature measurement. Based on the temperature measurement data of the thermostat 11, control of the heating means is executed. The fluid control device 6 that requires temperature measurement is the device that controls the flow rate, such as a mass flow controller (MFC), a flow control system (FCS) and the like. Passage blocks 6a and 6b provided on the left and right sides of the fluid control device 6 are respectively supported by the left and right block joints 8. A space S is formed between the left and right block joints 8.

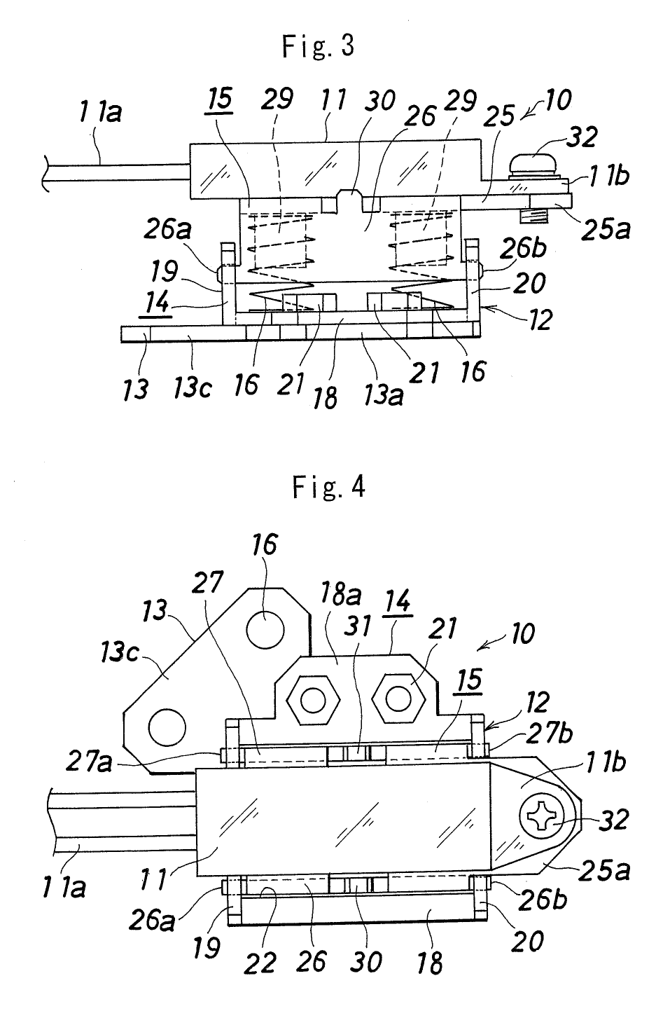

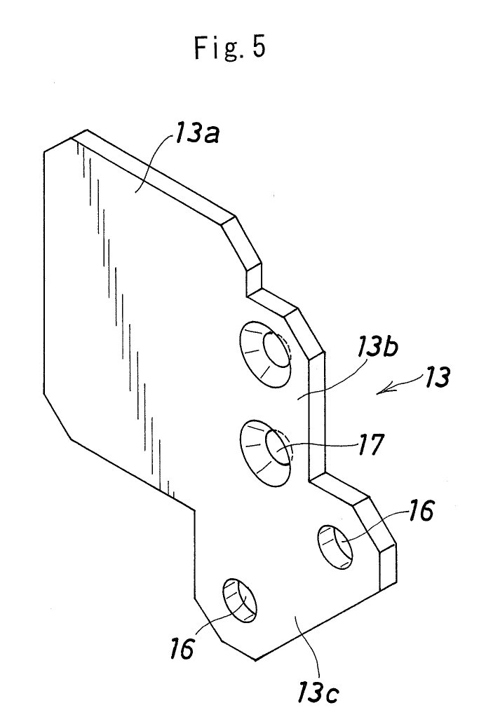

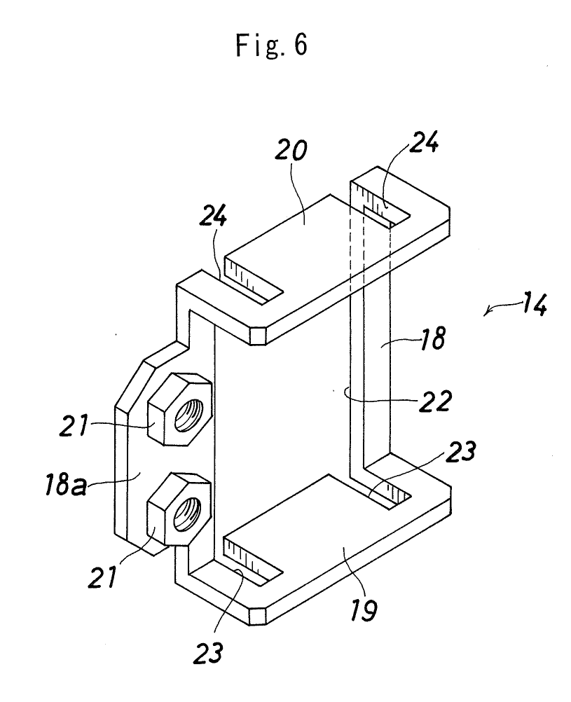

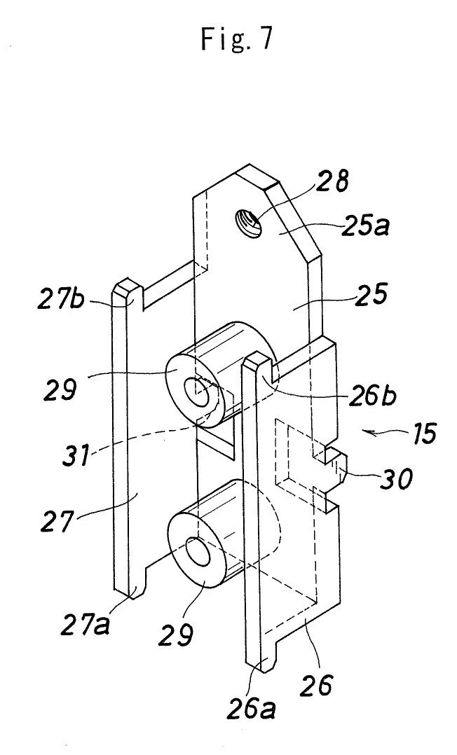

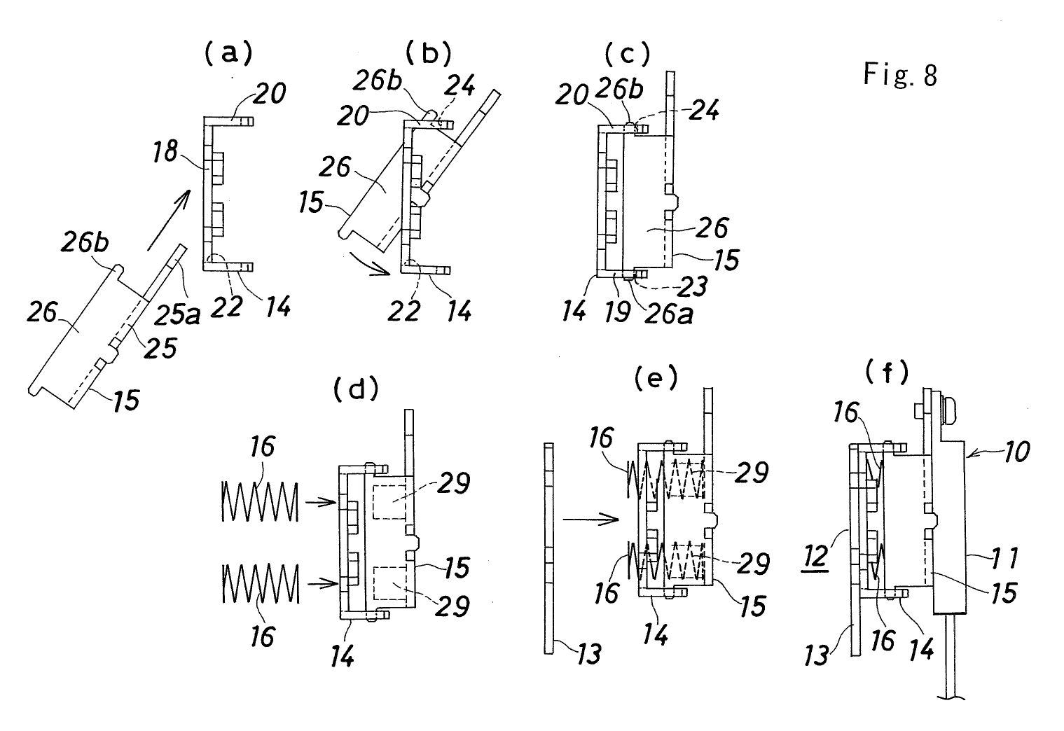

A detailed description will be given of the thermostat unit 10 with reference to FIGS. 3 to 8F. FIGS. 3 and 4 show the whole thermostat unit 10. FIG. 5 shows the first jig 13. FIG. 6 shows the second jig 14. FIG. 7 shows the third jig 15. FIGS. 8A to 8F show the assembly steps of the thermostat unit 10. In the following description, the terms, top, bottom, right, and left are used with reference to FIG. 3. The front surface side of FIG. 3 (the bottom side of FIG. 4) is defined as the front side, and the back surface side of FIG. 3 (the top side of FIG. 4) is defined as the rear side.

The thermostat unit 10 is structured with the thermostat 11 and the attachment jig 12 made up of the first to third jigs 13, 14, and 15 and a pair of compressed coil springs (biasing members) 16.

The first jig 13 is plate-like, and is made up of a substantially square-shaped body portion 13a, a rearward extending portion 13b that extends rearward from the body portion 13a, and a left rearward extending portion 13c extending left rearward from the body portion 13a. As shown in FIG. 4, the left rearward extending portion 13c is provided so as to stick out from the overlap portion of the thermostat unit 10 as seen two dimensionally, and provided with two screw insert holes 16 into which male screws (not shown) for fixing the thermostat unit 10 to the support member 9 are to be inserted. The rearward extending portion 13b is the portion overlapping with nut forming portion 18a of the second jig 14 in FIG. 4, and provided with two screw insert holes 17 into which male screws (not shown) for coupling to the second jig 14 are to be inserted.

The second jig 14 has a bottom wall 18 and left and right walls 19 and 20. The bottom wall 18 is rectangular, and provided with the nut forming portion 18a at its rear portion so as to stick out. At the nut forming portion 18a, two nuts 21 are fixed as being aligned on the right and left sides. The bottom wall 18 is provided with a rectangular hole 22 into which the third jig 15 can be inserted. At the left and right walls 19 and 20, a front and rear pair of guide grooves 23 and 24 that extends from the bottom end to the proximity of the top end is provided.

The third jig 15 has a top wall 25 and front and rear walls 26 and 27. The top wall 25 is provided with a rightward extending portion 25a where a female screw 28 is formed. At the bottom face of the top wall 25, two cylindrical downward projecting portions 29 used for attaching the compressed coil springs 16 are arranged as being aligned on the right and left sides. At the right and left center portions of the front and rear walls 26 and 27, upward projecting portions 30 and 31 where right and left edges of the base portion are cut off are provided. Bottom edge portions 26a, 26b, 27a, and 27b of the front and rear walls 26 and 27 are formed so as to project rightward and leftward than the portion at a level higher than the bottom edge portions 26a, 26b, 27a, and 27b.

The thermostat 11 is substantially oblong plate-shaped, and a lead 11a is lead out from the left end portion thereof. The thermostat 11 is provided with a rightward extending portion 11b to which a male screw 32 is provided. The rightward extending portion 25a of the third jig 15 where the female screw 28 is provided is structured so as to conform to the thermostat 11. By the thermostat 11 being placed on the top face of the top wall 25 and the male screw 32 of the thermostat 11 being screwed with the female screw 28, the thermostat 11 is fixed to the third jig 15. The upward projecting portions 30 and 31 of the front and rear walls 26 and 27 of the third jig 15 restrict the thermostat 11 from shifting frontward or rearward.

The third jig 15 is attached to the second jig 14 so as to be shiftable in upward and downward directions by having the bottom edge portions 26a, 26b, 27a, and 27b of the front and rear walls 26 and 27 fitted into the guide grooves 23 and 24 of the left and right walls 19 and 20 of the second jig 14. The rectangular hole 22 provided at the bottom wall 18 of the second jig 14 is for allowing the third jig 15 to be inserted from below the second jig 14. Since the guide grooves 23 and 24 are not opened upward, the second jig 14 is prevented from coming off upward from the third jig 15.

The compressed coil springs 16 are respectively fitted into from below the right and left cylindrical downward projecting portions 29 provided at the top wall 25 of the third jig 15, and held by the top wall 25 and the first jig 13 of the third jig 15 therebetween. Thus, the third jig 15 is capable of shifting in the top and bottom directions as being upwardly biased by the two compressed coil springs 16. The thermostat 11 placed on the third jig 15 is also capable of shifting in the top and bottom directions as being biased upwardly.

In assembling the thermostat unit 10, first, as shown in FIG. 8A, using the rectangular hole 22 of the bottom wall 18 of the second jig 14, the rightward extending portion 25a of the top wall 25 of the third jig 15 as the tip side is diagonally inserted from the bottom side of the second jig 14. Then, as shown in FIG. 8B, the front and rear walls 26 and 27 of the third jig 15 are aligned with the guide groove 24 of the right wall 20 of the second jig 14, and the bottom edge portions 26b and 27b are fitted into the guide groove 24. Next, as shown in FIG. 8B, the entire third jig 15 is inserted into the rectangular hole 22 of the bottom wall 18 of the second jig 14, and rotated so as to be parallel to the second jig 14. Then, as shown in FIG. 8C, the bottom edge portions 26a, 26b, 27a, and 27b of both the front and rear walls 26 and 27 of the third jig 15 are fitted into the guide grooves 23 and 24. Next, as shown in FIG. 8D, from below the second jig 14, the compressed coil springs 16 are attached to the two cylindrical downward projecting portions 29 of the third jig 15. Next, as shown in FIG. 8E, the first jig 13 is overlaid on the second jig 14 and they are fixed. Next, as shown in FIG. 8F, the thermostat 11 is fixed to the third jig 15. Thus, the thermostat unit 10 structured with the thermostat 11 and the attachment jig 12 made up of the first to third jigs 13, 14, and 15 and a pair of compressed coil springs (biasing members) 16 is assembled.

As shown in FIG. 1, the thermostat unit 10 is inserted into the space S between the fluid control device 6 and the support member 9 having the compressed coil spring 16 compressed. Here, the longitudinal direction of the thermostat 11 is not oriented in the aligning direction of the fluid control devices 2, 3, 4, 5, 6, and 7 as shown in FIG. 2, that is, not in the horizontal direction in FIG. 2, but is oriented diagonally to the aligning direction of the fluid control devices 2, 3, 4, 5, 6, and 7. Thus, even in the case where the line in which the fluid control devices 2, 3, 4, 5, 6, and 7 is arranged on the near side in FIG. 2, the lead 11a of the thermostat 11 can easily be lead out.

The thermostat unit 10 is attached to the fluid control apparatus 1 by the first jig 13 being fixed to the support member 9. That is, since the thermostat unit 10 is not directly fixed to the fluid control device 6, when the fluid control device 6 must be replaced, it is possible to replace solely the fluid control device 6 while leaving the thermostat unit 10 as it is. The thermostat unit 10 may be structured such that it can easily be inserted into the space S between the fluid control device 6 and the support member 9 previously arranged by compressing the compressed coil spring 16, and can easily be taken out without removing the fluid control device 6 from the fluid control apparatus 1.

Since the thermostat 11 is not directly fixed to the fluid control device 6, the sensitivity of the thermostat 11 may be reduced. However, since the compressed coil spring 16 is compressed, the thermostat 11 is biased by the elastic force of the compressed coil spring 16, and the thermostat 11 is pressed against the fluid control device 6. Thus, a reduction in sensitivity can be prevented.

What is claimed is:

1. A fluid control apparatus, comprising:
a support member;
a plurality of fluid control devices including a fluid control device requiring temperature measurement, a plurality of the fluid control devices being arranged so as to be adjacent to one another and attached to the support member; and
a space formed between the fluid control device requiring the temperature measurement and the support member, wherein
the thermostat is arranged in the space and allowed to abut on the fluid control device requiring the temperature measurement.

2. The fluid control apparatus according to claim 1, wherein
the thermostat is supported by an attachment jig attached to the support member, the thermostat being pressed against the fluid control device requiring the temperature measurement by a biasing member.

3. The fluid control apparatus according to claim 2, wherein
the attachment jig is made up of a first jig fixed to the support member, a second jig fixed to the first jig, and a third jig shiftably attached to the second jig, the thermostat being fixed to the third jig, and
the biasing member is interposed between the first jig and the third jig.

4. The fluid control apparatus according to claim 1, wherein
the thermostat is substantially oblong plate-shaped, wherein
a lead is lead out from one end portion of the thermostat, and
a longitudinal direction of the thermostat is diagonally oriented with reference to a direction in which the fluid control devices are aligned.

5. The fluid control apparatus according to claim 3, wherein
the first jig is plate-like, the first jig being made up of a substantially square-shaped body portion, a rearward extending portion that extends rearward from the body portion, and a left rearward extending portion extending left rearward from the body portion, wherein
the left rearward extending portion is provided with at least one screw insert hole through which a male screw for fixing the thermostat unit to the support member is inserted, and
the rearward extending portion is provided with at least one screw insert hole through which a male screw for coupling to the second jig is inserted.

6. The fluid control apparatus according to claim 3, wherein
the second jig has a bottom wall and left and right walls,
the bottom wall has a rectangular shape,
a nut forming portion is formed at a rear portion of the bottom wall so as to stick out,
at least one nut is fixed to the nut forming portion,
the bottom wall is provided with a rectangular hole that allows the third jig to be inserted, and
the left and right walls are provided with a front and rear pair of guide grooves extending from a bottom end to a proximity of a top end.

7. The fluid control apparatus according to claim 3, wherein
the third jig has a top wall and front and rear walls,
the top wall is provided with a rightward extending portion where a female screw is provided,
a bottom face of the top wall is provided with two cylindrical downward projecting portions each used for attaching a biasing member,
right and left center portions of the front and rear walls are provided with upward projecting portions where right and left edges of the base portion are cut out, and
bottom edge portions of the front and rear walls are formed so as to project rightward and leftward than a portion at a level higher than the bottom edge portions.
